(19) United States
(12) Patent Application Publication
(10) Pub. No.: US 2006/0147943 A1
(43) Pub. Date: Jul. 6, 2006

(54) Substrates having pendant epoxide groups for binding biomolecules and methods of making and using thereof

(76) Inventor: Mark A. Lewis, Corning, NY (US)

Correspondence Address: CORNING INCORPORATED, SP-TI-3-1, CORNING, NY, 14831, US

(21) Appl. No.: 11/027,318

(22) Filed: Dec. 30, 2004

(51) Int. Cl. C40B 40/08; C40B 40/10

(52) U.S. Cl. 435/6; 435/7.1; 435/287.2

(57) ABSTRACT

Described herein are substrates having one or more pendant epoxide groups capable of being attached to one or more different biomolecules and methods of making and using thereof.

### BACKGROUND

Analysis of the structure, organization and sequence of biomolecules such as, for example, nucleic acids, is important in the prediction, diagnosis and treatment of human disease and in the study of gene discovery, expression, and development. One laboratory tool used in the analysis of nucleic acids is the high density array (HDA). The HDA provides the framework for immobilization of biomolecules such as nucleic acids for analysis on a rapid, large-scale basis. HDAs generally include a substrate having a large number of positionally distinct DNA probes attached to a surface of the substrate for subsequent hybridization to a DNA target.

The surfaces of both organic and inorganic substrates can be modified by the deposition of a polymeric monolayer coating or film to construct biomolecular assemblies. In addition, surface modification can also be used to promote adhesion and lubrication, modify the electrical and optical properties of the substrate surface, and create electroactive films suitable for various optical and electronic sensors and devices.

A consideration in the preparation of substrates for immobilization of biomolecules is uniformity of the substrate surface. It is important to provide uniform functionality over an extended area of the substrate. This is especially true in the case of high density arrays for performing biomolecular hybridization assays. Such assays rely on having uniform levels of biomolecule immobilization at known locations on the substrate. It is desirable to have substantially identically sized spots containing a known quantity of pre-determined set of capture biomolecules located on the substrate in a regular geometric array with low background or low noise. Ambiguous and/or erroneous readouts result from variations in the immobilization and localization of the capture biomolecules.

Another consideration for the immobilization of biomolecules onto a solid substrate is the mode of attachment of the biomolecule to the substrate. Immobilization of biomolecules to a substrate can be achieved through non-covalent bonds (e.g., electrostatic bonds) or covalent bonds. Current substrates coated with aminosilane compounds are available for the electrostatic immobilization of biomolecules such as cDNA and long oligos for the purpose of doing gene expression profiling (GEP). The drawback of electrostatic immobilization is that it does not do very well with short oligos due to the substantial loss of material during processing and the limited number of binding events that can occur while still being able to get good hybridization.

It would be desirable to provide substrates with alternate surface modifications that can immobilize a biomolecule by electrostatic and covalent means, where the electrostatic component allows for better control of the spot size of the printed material by temporarily holding the material in place negating the inherent capillary action of say, a porous material, and the covalent component, which takes longer to occur, permanently immobilizes the biomolecule by reducing the amount of material that is typically lost during subsequent processing (e.g., prehybridization, hybridization, washing, etc.).

Described herein are substrates having one or more pendant epoxide groups capable of being attached to one or more different biomolecules and methods of making and using thereof. The methods for making and using the substrates described herein provide numerous advantages over the art. For example, the substrates can be prepared by chemical vapor deposition, which avoids the use of solvents and subsequent processing steps. Additionally, the supports described herein can be used to immobilize a number of biomolecules that otherwise could not be immobilized and subsequently processed.

### SUMMARY

Described herein are supports for immobilizing molecules, particularly biomolecules, methods of making and using such supports, and kits. The advantages of the materials, methods, and articles described herein will be set forth in part in the description which follows, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate several aspects described below. It will be appreciated that these drawings depict only typical embodiments of the materials, articles, and methods described herein and are therefore not to be considered limiting of their scope.

FIG. 1 shows an example of a support of the invention, where the tie layer is derived from gamma-aminopropylsilane and the epoxide layer is derived from 1,4-butanediol diglycidyl ether.

FIG. 2 shows a reaction vessel for producing supports of the invention by chemical vapor deposition.

FIG. 3 shows the fluorescence of several printed DNA from different spotting solutions Cy5 on a bis-epoxy slide (30 minutes at 60° C.).

FIG. 4 shows the fluorescence of several printed DNA from different spotting solutions Cy3 on a bis-epoxy slide (10 minutes at 90° C.).

FIG. 5 is a bar graph showing the net signal intensity of the printed DNA (Cy5 on a bis-epoxy slide; 30 minutes at 60° C).

FIG. 6 is a bar graph showing the net signal intensity of the printed DNA (Cy3 on a bis-epoxy slide; 10 minutes at 90° C.).

FIG. 7 shows the hybridization enhancement of cDNA and long/short oligos on GAPS porous slides and bis-epoxy slides.

### DETAILED DESCRIPTION

Before the present materials, articles, and/or methods are disclosed and described, it is to be understood that the aspects described below are not limited to specific compounds, synthetic methods, or uses as such may, of course, vary. It is also to be understood that the terminology used herein is for the purpose of describing particular aspects only and is not intended to be limiting.

In this specification and in the claims that follow, reference will be made to a number of terms that shall be defined to have the following meanings:

Throughout this specification, unless the context requires otherwise, the word “comprise,” or variations such as “comprises” or “comprising,” will be understood to imply the inclusion of a stated integer or step or group of integers or steps but not the exclusion of any other integer or step or group of integers or steps.

It must be noted that, as used in the specification and the appended claims, the singular forms “a,” “an” and “the” include plural referents unless the context clearly dictates otherwise. Thus, for example, reference to “a pharmaceutical carrier” includes mixtures of two or more such carriers, and the like.

“Optional” or “optionally” means that the subsequently described event or circumstance can or cannot occur, and that the description includes instances where the event or circumstance occurs and instances where it does not.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

A weight percent of a component, unless specifically stated to the contrary, is based on the total weight of the formulation or composition in which the component is included.

Variables such as R¹—R⁴, n, L, X, Y, and Z used throughout the application are the same variables as previously defined unless stated to the contrary.

The term “alkyl group” as used herein is a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl and the like. A “lower alkyl” group is an alkyl group containing from one to six carbon atoms.

The term “polyalkylene group” as used herein is a group having two or more CH₂ groups linked to one another. The polyalkylene group can be represented by the formula —CH₂)ₚ—, where p is an integer of from 2 to 25.

The term “polyether group” as used herein is a group having the formula [(CHR)ₚO]ₘ—, where R is hydrogen or a lower alkyl group, p is an integer of from 1 to 20, and m is an integer of from 1 to 100. Examples of polyether groups include, polyethylene oxide, polypropylene oxide, and polybutylene oxide.

The term “polythioether group” as used herein is a group having the formula —[(CHR)ₚS]ₘ—, where R is hydrogen or a lower alkyl group, p is an integer of from 1 to 20, and m is an integer of from 1 to 100.

The term “polyamino group” as used herein is a group having the formula —[(CHR)ₚNR]ₘ—, where each R is, independently, hydrogen or a lower alkyl group, p is an integer of from 1 to 20, and m is an integer of from 1 to 100.

Disclosed are compounds, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a number of different polymers and biomolecules are disclosed and discussed, each and every combination and permutation of the polymer and biomolecule are specifically contemplated unless specifically indicated to the contrary. Thus, if a class of molecules A, B, and C are disclosed as well as a class of molecules D, E, and F and an example of a combination molecule, A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

I. Supports

Described herein are supports for binding biomolecules. In one aspect, described herein is a support comprising a substrate having an outer surface, a tie layer, and an epoxide layer, wherein the tie layer is attached to the outer surface of the substrate, and the epoxide layer is attached to the tie layer, wherein the epoxide layer has at least one epoxide group.

In one aspect, the tie layer is attached to the outer surface of the substrate. The term “outer surface” with respect to the substrate is the region of the substrate that is exposed and can be subjected to manipulation. For example, any surface on the substrate that can come into contact with a solvent or reagent upon contact is considered the outer surface of the substrate. The substrate itself may take any shape including, but not limited to, rectangular, square, circular, cylindrical, conical, planar and spherical. The interior surface of a bottle or tubing could be used as a substrate. The substrates that can be used herein include, but are not limited to, a microplate, a slide, or an array. In one aspect, when the substrate is a microplate, the number of wells and well volume will vary depending upon the scale and scope of the analysis. Alternatively, the microplate can have a glass bottom.

For optical or electrical areas of application, the substrate can be transparent, impermeable, or reflecting, as well as electrically conducting, semiconducting, or insulating. For biological applications, the substrate material may be either porous or nonporous and may be selected from either organic or inorganic materials.

In one aspect, the substrate comprises a plastic, a polymeric or co-polymeric substance, a ceramic, a glass, a metal, a crystalline material, a noble or semi-noble metal, a metallic or non-metallic oxide, a transition metal, or any combination thereof. Additionally, the substrate can be configured so that it can be placed in any detection device. In one aspect, sensors can be integrated into the bottom/underside of the substrate and used for subsequent detection. These sensors could include, but are not limited to, optical gratings, prisms, electrodes, and quartz crystal microbalances. Detection methods could include fluorescence, phosphorescence, chemiluminescence, refractive index, mass, electrochemical. In one aspect, the substrate is a Corning LID microplate.

In one aspect, the substrate can be composed of an inorganic material. Examples of inorganic substrate materials include, but are not limited to, metals, semiconductor materials, glass, and ceramic materials. Examples of metals that can be used as substrate materials include, but are not limited to, gold, platinum, nickel, palladium, aluminum, chromium, steel, and gallium arsenide. Semiconductor materials used for the substrate material include, but are not limited to, silicon and germanium. Glass and ceramic materials used for the substrate material can include, but are not limited to, quartz, glass, porcelain, alkaline earth aluminoborosilicate glass and other mixed oxides. Further examples of inorganic substrate materials include graphite, zinc selenide, mica, silica, lithium niobate, and inorganic single crystal materials.

In another aspect, the substrate comprises a porous, inorganic layer. Any of the porous substrates and methods of making such substrates disclosed in U.S. Pat. No. 6,750,023, which is incorporated by reference in its entirety, can be used herein. In one aspect, the inorganic layer on the substrate comprises a glass or metal oxide. In another aspect, the inorganic layer comprises a silicate, an aluminosilicate, a boroaluminosilicate, a borosilicate glass, or a combination thereof. In a further aspect, the inorganic layer is TiO₂, SiO₂, Al₂O₃, Cr₂O₃, CuO, ZnO, Ta₂O₅, Nb₂O₅, or ZnO₂.

In another aspect, the substrate can be composed of an organic material. Organic materials useful herein can be made from polymeric materials due to their dimensional stability and resistance to solvents. Examples of organic substrate materials include, but are not limited to, polyesters, such as polyethylene terephthalate and polybutylene terephthalate; polyvinylchloride; polyvinylidene fluoride; polytetrafluoroethylene; polycarbonate; polyamide; poly(meth)acrylate; polystyrene, polyethylene; or ethylene/vinyl acetate copolymer.

The substrates described herein have a tie layer attached to the substrate. The term “attached” as used herein is any chemical interaction between two components or compounds. The type of chemical interaction that can be formed when the tie layer compound is attached to the substrate will vary depending upon the material of the substrate and the compound used to produce the tie layer. In one aspect, the tie layer can be covalently attached to the substrate. For example, the outer surface of the substrate can be derivatized so that there are groups capable of forming a covalent bond with the tie layer compound. In another aspect, the tie layer is non-covalently attached to the substrate. Examples of non-covalent attachments include, but are not limited to, electrostatic interactions, ionic interactions, hydrogen bonding, Van Der Waals interactions, and dipole-dipole interactions. In one aspect, when the tie layer is electrostatically attached to the substrate, the compound used to make the tie layer is positively charged and the outer surface of the substrate is treated such that a net negative charge exists so that the tie layer compound and the outer surface of the substrate form an electrostatic bond.

In one aspect, the tie layer comprises one or more reactive functional groups that can react with an epoxide group. Examples of reactive functional groups include, but are not limited to, an amino group, a thiol group, or a hydroxyl group. The functional groups permit the attachment of the epoxide to the tie layer. In one aspect, the tie layer is derived from a straight or branched-chain aminosilane, aminoalkoxysilane, aminoalkylsilane, aminoarylsilane, aminoaryloxysilane, or a derivative or salt thereof. The phrase “derived from” with respect to the tie layer is defined herein as the resulting residue or fragment of the tie layer compound when it is attached to the substrate. In a further aspect, the tie layer is derived from 3-aminopropyl trimethoxysilane, N-(beta-aminoethyl)-3-aminopropyl trimethoxysilane, N-(beta-aminoethyl)-3-aminopropyl triethoxysilane, N′-(beta-aminoethyl)-3-aminopropyl methoxysilane, or aminopropylsilsesquixoane. In another aspect, the tie layer is derived from a polyamine such as, for example, poly-lysine or polyethyleneimine. In another aspect, the tie layer is not derived from a triamine compound (i.e., a compound having three substituted or unsubstituted amino groups).

The epoxide layer can be attached to the tie layer by a covalent bond and/or non-covalent bond as described above. In one aspect, the epoxide layer is derived from a bis-epoxide compound. Not wishing to be bound by theory, the tie layer possesses a reactive functional group that is capable of forming a covalent or non-covalent bond with the bis-epoxide compound by reacting with one of the epoxide groups.

In one aspect, wherein the bis-epoxide compound has the formula II 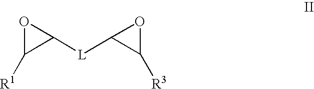
wherein L is a residue of a linker; and
R¹ and R³ are, independently hydrogen, an alkyl group, a polyalkylene group, a polyether group, a polyamino group, group, or a polythioether group. The selection of R¹, R³, and L in formula II will vary depending upon the tie layer and biomolecule selected. In one aspect, R¹, R³, and L do not compete with the reactivity of the epoxide group. In one aspect, the linker L comprises a residue of an ether group, a polyalkylene group, a polyether group, a polyamino group, group, or a polythioether group. In another aspect, the linker L has the formula CH₂Y(CH₂)ₙZCH₂, wherein Y and Z are, independently, S, O, or NR⁴, wherein R⁴ is hydrogen or an alkyl group, and n is an integer from 1 to 10,000. In one aspect, the lower endpoint of n is 1, 2, 4, 6, 8, 10, 20, 30, 40, 50, 100, 200, 300, 400, 500, and the upper endpoint is 100, 200, 300, 400, 500, 600, 700, 800, 900, 1,000, 2,000, 3,000, 4,000, 5,000, 6,000, 7,000, 8,000, 9,000, or 10,000, where any lower end-point can be combined with any upper end-point to create a range for n. In one aspect, the linker L has the formula CH₂Y(CH₂)ₙZCH₂, wherein Y and Z are, independently, S, O, or NR⁴, wherein R⁴ is hydrogen or an alkyl group, and n is an integer from 1 to 10. In a further aspect, the linker L has the formula CH₂O(CH₂)ₙOCH₂, wherein n is 2, 3, 4 or 5. In another aspect, L is polyethylene oxide. In one aspect, R¹ and R³ are hydrogen.

In one aspect, the bis-epoxide compound is a liquid having a boiling point less than 225° C., less than 200° C., less than 175° C., less than 150° C., or less than 125° C. at atmospheric pressure or reduced pressure (less than atmospheric pressure).

In another aspect, the tie layer and epoxide layer comprises the residue of formula I 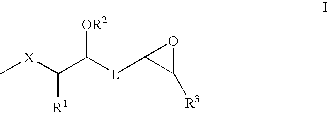
wherein X is a residue of the tie layer;
L is a residue of a linker; and
R¹, R², and R³ are, independently, hydrogen, an alkyl group, a polyalkylene group, a polyether group, a polyamino group, group, or a polythioether group, wherein the residue having the formula I is covalently attached to outer surface of the substrate through X.

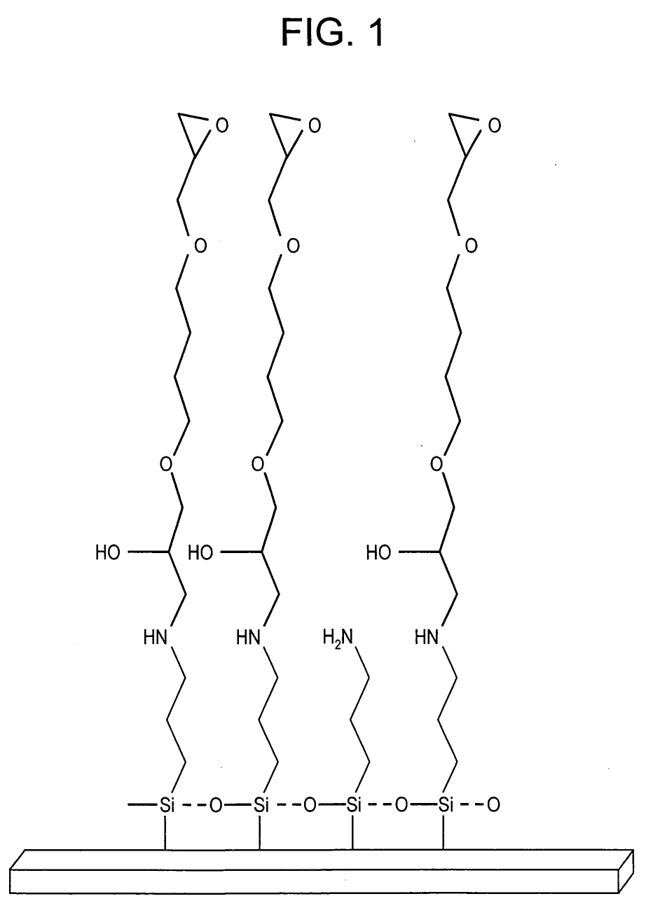

In one aspect, the substrate comprises a porous, inorganic layer, the tie layer is derived from 3-aminopropyl trimethoxysilane, and the epoxide layer is derived from 1,4-butanediol diglycidyl ether. This aspect is depicted in FIG. 1.

It is contemplated that the tie layer and epoxide layer can be derived from different tie layer compounds and epoxide layer compounds, respectively. Thus, the tie layer can be derived from one tie layer compound or two or more different tie layer compounds. The same applies to the epoxide layer.

It is contemplated that one or more different biomolecules can be attached to the epoxide layer. The biomolecule can be attached covalently or non-covalently to the epoxide layer. The biomolecules may exhibit specific affinity for another molecule through covalent or non-covalent bonding. Examples of biomolecules useful herein include, but are not limited to, a ribonucleic acid, a deoxyribonucleic acid, a synthetic oligonucleotide, an antibody, a protein, a peptide, a lectin, a modified polysaccharide, a synthetic composite macromolecule, a functionalized nanostructure, a synthetic polymer, a modified/blocked nucleotides/nucleoside, a modified/blocked amino acid, a fluorophore, a chromophore, a ligand, a chelate, or a hapten. When the biomolecule is a nucleic acid, the size of the nucleic acid can vary from a very short oligonucleotide (e.g., 30 mer) to cDNA. Methods for attaching the biomolecule to the epoxide layer will be discussed below.

II. Methods for Preparing Supports

Described herein are methods for preparing a support comprising (1) attaching a tie layer compound to the outer surface of a substrate, wherein the tie layer compound has at least one functional group capable of reacting with an epoxide group, and (2) reacting the tie layer with an epoxide compound having at least two epoxide groups to produce an epoxide layer, wherein the epoxide layer has at least one epoxide group. Any of the substrates, tie layer compounds, and epoxide compounds described above can be used in the methods described herein to produce the support. The methods contemplate the sequential attachment of the tie layer compound to the substrate to produce a tie layer followed by attaching the epoxide compound to the tie layer to produce the epoxide layer. Alternatively, it is contemplated to attach the epoxide compound to the tie layer compound followed by attaching the tie layer/epoxide layer to the substrate.

The tie layer and epoxide layer can be attached to the substrate using techniques known in the art. For example, the substrate can be dipped in a solution of the tie compound followed by dipping the substrate in a solution of epoxide compound. In this aspect, the substrate with the tie layer is reacted with the epoxide compound in the solution phase. In another aspect, the tie compound and/or epoxide compound can be sprayed, vapor deposited, screen printed, or robotically pin printed or stamped on the substrate. This could be done either on a fully assembled substrate or on a bottom insert (e.g., prior to attachment of the bottom insert to a holey plate to form a microplate).

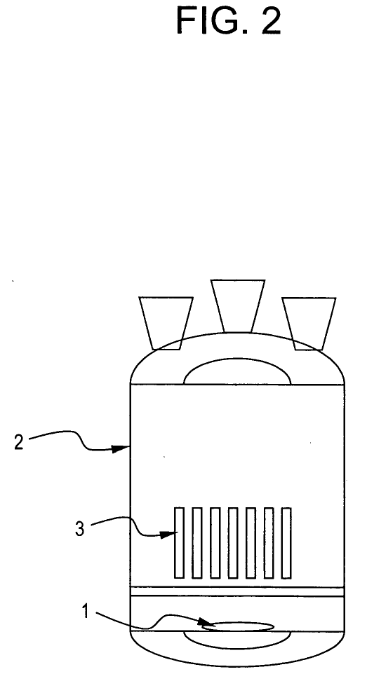

In one aspect, described herein is a method for preparing a support comprising (1) attaching a tie layer compound to the outer surface of a substrate, wherein the tie layer compound has at least one functional group capable of reacting with an epoxide group, and (2) reacting the tie layer with an epoxide compound having at least two epoxide groups to produce an epoxide layer, wherein the epoxide layer has at least one epoxide group, wherein step (2) is performed by chemical vapor deposition. Chemical vapor deposition is a technique well-known in the art for depositing a material on a surface. In one aspect, the epoxide compound reacts with the tie layer in the vapor phase. In this aspect, the epoxide compound is condensed on the tie layer, wherein the epoxide compound reacts with the tie layer. An example of this aspect is depicted in FIG. 2. Referring to FIG. 2, neat bis-epoxide compound 1 is placed in reaction vessel 2 and heated in order to warm or vaporize a portion of the bis-epoxide compound. The time and amount of heat used will vary depending upon the selection of the bis-epoxide compound. The vessel can be heated using techniques known in the art. In one aspect, the heating step is performed by immersing the reaction vessel in a heated oil bath. Next, the substrate 3 with a tie layer attached to it is placed in reaction vessel 2, and the vessel is sealed. The time and amount of the second heating step will vary depending upon the selection of the substrate, the tie layer, and bis-epoxide compound, which can be determined by one of ordinary skill in the art. In one aspect, the second heating step can be performed under an inert atmosphere of nitrogen or another inert gas.

Once the tie layer and epoxide layer have been attached to the substrate, one or more biomolecules can be attached to the epoxide layer using techniques known in the art. For example, various techniques are known in the art for immobilizing DNA and oligonucleotides on surfaces. A discussion of representative immobilization techniques used in the art can be found in U.S. Pat. No. 5,919,626 and the references listed in that patent, which are incorporated by reference for their teachings. Similarly, immobilization techniques are known for other biomolecules, such as specific binding members. Additionally, techniques for immobilization of molecules useful in tissue culture systems, e.g., collagen, are also well-known in the art. In one aspect, the supports described herein can be used to immobilize a variety of biomolecules including, but not limited to, DNA arrays, oligonucleotides, protein arrays and cell arrays.

The amount of biomolecule that can be attached to the epoxide layer can vary depending upon, for example, the selection of the biomolecule and the epoxide layer, and the conditions at which attachment occurs (e.g., pH).

III. Methods of Use

Described herein are methods for performing an assay of a ligand, comprising (1) contacting the ligand with a support comprising a substrate having an outer surface, a tie layer, an epoxide layer, and a biomolecule, wherein the tie layer is attached to the outer surface of the substrate, the epoxide layer is attached to the tie layer, wherein the epoxide layer has at least one epoxide group, wherein the biomolecule is covalently attached and/or non-covalently attached the epoxide layer, and (2) detecting the immobilized ligand.

Any of the substrates described herein having one or more biomolecules attached thereto can be used to bind a ligand, wherein the bound ligand can ultimately be detected. The binding of the ligand to the substrate involves a chemical interaction between the biomolecule and the ligand; however, it is possible that an interaction may occur to some extent between the epoxide layer and the ligand. The nature of the interaction between the biomolecule and the ligand will vary depending upon the biomolecule and the ligand selected. In one aspect, the interaction between the biomolecule and the ligand can result in the formation of a covalent bond and/or non-covalent bond.

The ligand can be any naturally-occurring or synthetic compound. Examples of ligands that can be bound to the biomolecules on the substrate include, but are not limited to, a drug, an oligonucleotide, a nucleic acid, a protein, a peptide, an antibody, an antigen, a hapten, or a small molecule (e.g., a pharmaceutical drug). Any of the biomolecules described above can be a ligand for the methods described herein. In one aspect, a solution of one or more ligands is prepared and added to one or more wells that have a biomolecule attached to the outer surface of the microplate. In this aspect, it is contemplated that different biomolecules can be attached to different wells of the microplate; thus, it is possible to detect a number of different interactions between the different biomolecules and the ligand. In one aspect, a protein can be immobilized on the microplate to investigate the interaction between the protein and a second protein or small molecule. Alternatively, a small molecule can be immobilized on the microplate using the techniques described herein to investigate the interaction between the small molecule and a second small molecule or protein. In one aspect, when the substrate is a microplate, the assay can be a high-throughput assay. In another aspect, the supports described herein can be used as gene expression assays.

Once the ligand has been bound to the biomolecules on the substrate, the bound ligand is detected. In one aspect, the bound ligand is labeled for detection purposes. Depending upon the detection technique used, in one aspect, the ligand can be labeled with a detectable tracer prior to detection. The interaction between the ligand and the detectable tracer can include any chemical or physical interaction including, but not limited to, a covalent bond, an ionic interaction, or a Lewis acid-Lewis base interaction. A “detectable tracer” as referred to herein is defined as any compound that (1) has at least one group that can interact with the ligand as described above and (2) has at least one group that is capable of detection using techniques known in the art. In one aspect, the ligand can be labeled prior to immobilization. In another aspect, the ligand can be labeled after it has been immobilized. Examples, of detectable tracers include, but are not limited to, fluorescent and enzymatic tracers.

In another aspect, detection of the bound ligand can be accomplished with other techniques including, but not limited to, fluorescence, phosphorescence, chemilumenescence, bioluminescence, Raman spectroscopy, optical scatter analysis, mass spectrometry, etc. and other techniques generally known to those skilled in the art. In one aspect, the immobilized ligand is detected by label-independent detection or LID. Examples of LID include, but are not limited to, surface plasmon resonance or a resonant waveguide gratings (e.g. Corning LID system).

Also described herein are kits for immobilizing one or more biomolecules comprising (1) a substrate having a tie layer comprising at least one functional group capable of reacting with an epoxide group and (2) an epoxide compound having at least two epoxide groups. In this aspect, it is contemplated that the substrate with the tie layer is contacted with either neat epoxide compound or a solution of epoxide compound. The kit can also contain one or biomolecules that can be attached to the support.

### EXAMPLES

The following examples are put forth so as to provide those of ordinary skill in the art with a complete disclosure and description of how the materials, articles, and methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

A. Preparation of Support

The reaction vessel was cleaned and baked out in an oven at 100° C. overnight then cooled down in a nitrogen atmosphere. A lattice (shark cage), which was also cleaned and baked, was placed inside the vessel during the cooling process. The vessel was then immersed into the preheated oil bath and allowed to equilibrate for 5 minutes. The bis-epoxy compound 1,4-butanediol diglycidyl ether was then added (neat) to the chamber and allowed to equilibrate for 5 minutes. The shark cage was then removed and porous slides coated with gamma-aminopropyl silane were placed into the cage and the cage was placed back into the chamber. The coating was allowed to proceed for 5 minutes. After the coating time had elapsed, the slides were removed and placed into a staining dish then placed in an oven at 100° C. for 30 minutes without a cover. The slides were then removed and allowed to cool in a hood to room temperature with the glass lid covering the staining dish. Once the slides were cooled, they were placed into TOPAZ mailers and put into a dessicator until needed.

B. DNA Immobilization

i. Printing of DNA

The DNA was printed on slides produced in Example A using a Point Technologies PTL 3000 quill pin. The DNA that was printed was ACTB (actin, beta), EEF1D (eukaryotic translation elongation factor 1 delta (guanine nucleotide exchange protein), DCTD (dCMP deaminase), and HADHB (hydroxyacyl-Coenzyme A dehydrogenase/3-ketoacyl-Coenzyme A thiolase/enoyl-Coenzyme A hydratase (trifunctional protein), beta subunit). In FIG. 4, the following buffer solutions were used: (RP=Reactive Porous) RP004=40% DMSO, 100 mM sodium phosphate monobasic, pH 6.03; RP017=70% DMSO, 50 mM sodium phosphate monobasic, pH 7.34; RP006=40% ethylene glycol, 100 mM sodium phosphate monobasic, pH 4.81; and RP015=70% ethylene glycol, 100 mM sodium phosphate monobasic, pH 5.00.

ii. Hybridization Protocol

Prehybridization

The printed DNA slides produced above were prehybridized using the following protocols (steps 1-6) (each at 100 mL with agitation).
1) 2×SSC/0.5% SDS with 0.5 g NaBH₄
   a) Time—30 minutes
   b) Temp—40° C.
   c) Cycles—1
2) 1×SSC
   a) Time—30 seconds
   b) Temp—RT
   c) Cycles—3
3) 2×SSC/0.05% SDS/0.2% BSA (0.2%=0.2 g)
   a) Time—30 minutes
   b) Temp—42° C.
   c) Cycles—1
4) 1×SSC
   a) Time—1 minute
   b) Temp—RT
   c) Cycles—1
5) 0.2×SSC
   a) Time—1 minute
   b) Temp—RT
   c) Cycles—3
6) Dry—2,000 rpm in open 25 slide mailer for 3 minutes
   Hybridization

The following hybridization solutions and steps were performed:
1) Hybe Solution: 7×SSC/10% Formamide/0.1% SDS/0.2% BSA
   a. Cy3 Total Reference RNA—1.63 μl (4 pmol)×5.5 hybes=8.15 μl
   b. Cy5 Total Reference RNA—2.69 μl (4 pmol)×5.5 hybes=13.45 μl
   c. Hybe Solution—60 μl per slide×5.5 hybes=330 μl
2) Heat probe solution in individual microtubes (60 μl/tube) for 3 minutes. Centrifuge at 12,000 rpm for 1 minute. Place on 42° C. heat block until use.
3) Apply 60 μl per slide using a 24 mm×60 mm glass coverslip
4) Incubate the slides in humid tip box overnight at 42° C. (3 slides per box)
   Post-Hybridization

The following post hybridization protocol was performed (100 ml volumes with agitation):
1) 2×SSC/0.05% SDS
   a) Time—5 minute
   b) Temp—42° C.
   c) Cycles—2
2) 1×SSC
   a) Time—5 minutes
   b) Temp—RT
   c) Cycles—1
3) 0.2×SSC
   a) Time—2 minutes
   b) Temp—RT
   c) Cycles—2
4) Dry—2,000 rpm in open 25 slide mailer for 3 minutes
5) Hybridization scans of all slides at PMT 700

iii. Results

The six spotting solutions all gave a spot diameter in the range of 200 μm using a Point Technologies PTL 3000 quill pin. Multiple spotting solutions performed well using the bis-epoxy slide produced in Example A and give appropriate spot diameters which are comparable to diameters on GAPS porous slides using the Universal Spotting Solution.

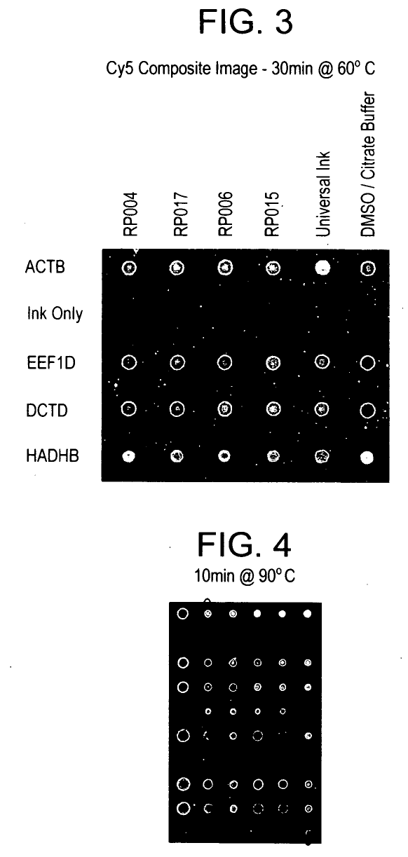

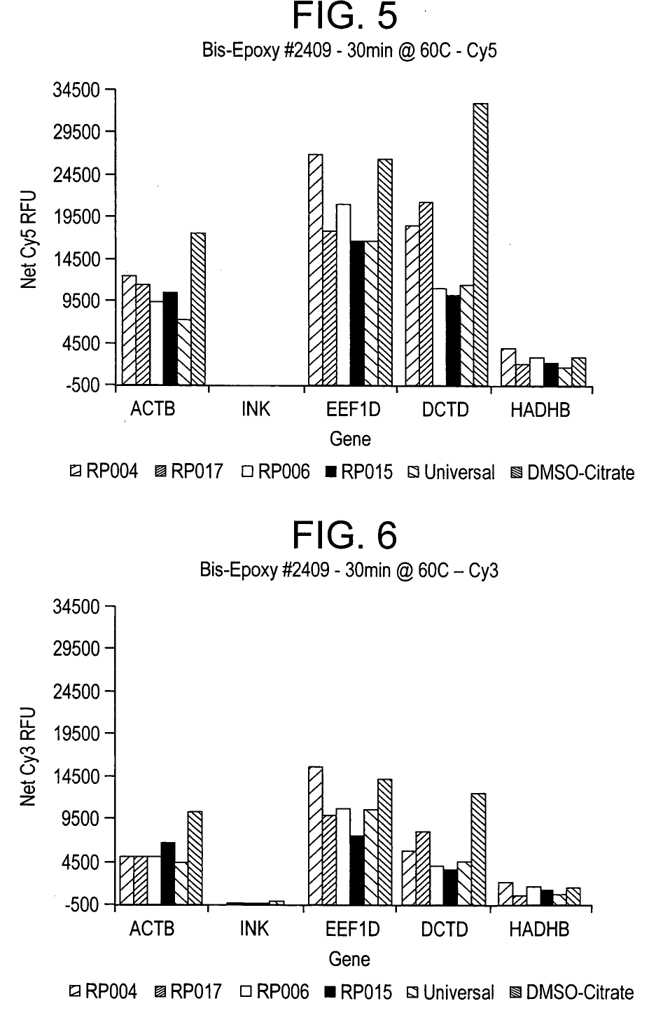

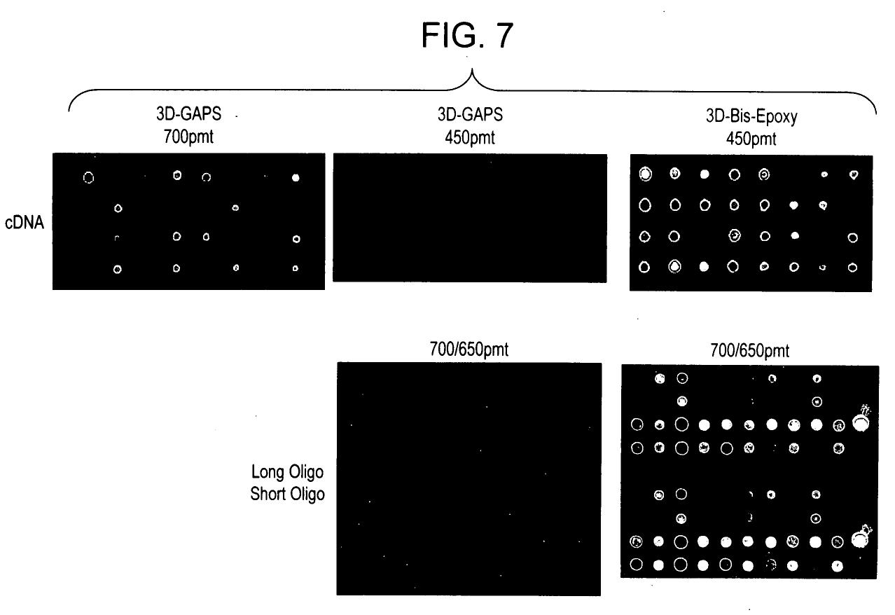

FIGS. 3 and 4 show the fluorescence of several printed DNA from different spotting solutions (Cy5 and Cy3, respectively) on the bis-epoxy slide produced in Example A. FIGS. 5 and 6 are bar graphs showing the net signal intensity of the printed DNA in FIGS. 3 and 4, respectively. The overall best performing spotting solutions were RP004 and the cDNA GEN I (DMSO/Citrate buffer) solution when comparing the net signal intensity and the amount of local spot background after printing. The other four inks that performed well gave undesirable background fluorescence around the printed spot in the area of the solvent front of the spotting solution. FIG. 7 shows that the use of the bis-epoxy slide produced in Example A results in 58 to 100 times hybridization enhancement when compared to GAPS porous slides for cDNA. For long and short oligos, the enhancement is in the range of 5 to 50 times when compared to GAPS porous.

Throughout this application, various publications are referenced. The disclosures of these publications in their entireties are hereby incorporated by reference into this application in order to more fully describe the compounds, compositions and methods described herein.

Various modifications and variations can be made to the materials, methods, and articles described herein. Other aspects of the materials, methods, and articles described herein will be apparent from consideration of the specification and practice of the materials, methods, and articles disclosed herein. It is intended that the specification and examples be considered as exemplary.

### REFERENCES

1. Sung-Kay CHIU, Mandy HSU, Wei-Chi KU, Ching-Yu TU, Yu-Tien TSENG, Wai-Kwan LAU, Rong-Yih YAN, Jing-Tyan MA and Chi-Meng TZENG “Synergistic effects of epoxy- and amine-silanes on microarray DNA immobilization and hybridization,” Biochem. J. (2003) 374, 625-632 (Printed in Great Britain)
2. Patent application Pub. No. US 2003/0059819 A1
3. Patent application Pub. No. US 2004/0086939 A1
4. U.S. Pat. No. 6,750,023

What is claimed is:

1. A support comprising a substrate having an outer surface, a tie layer, and an epoxide layer, wherein the tie layer is attached to the outer surface of the substrate, and the epoxide layer is attached to the tie layer, wherein the epoxide layer has at least one epoxide group.

2. The support of claim 1, wherein the substrate comprises a plastic, a polymeric or co-polymeric substance, a ceramic, a glass, a metal, a crystalline material, a noble or semi-noble metal, a metallic or non-metallic oxide, a transition metal, or any combination thereof.

3. The support of claim 1, wherein the substrate comprises a porous, inorganic layer.

4. The support of claim 3, wherein the inorganic layer comprises a glass or metal oxide.

5. The support of claim 3, wherein the inorganic layer comprises a silicate, an aluminosilicate, a boroaluminosilicate, a borosilicate glass, or a combination thereof.

6. The support of claim 3, wherein the inorganic layer is TiO₂, SiO₂, Al₂O₃, Cr₂O₃, CuO, ZnO, Ta₂O₅, Nb₂O₅, or ZnO₂.

7. The support of claim 1, wherein the tie layer is derived from a compound comprising one or more functional groups that can react with an epoxide group.

8. The support of claim 7, wherein the functional group comprises an amino group, a thiol group, or a hydroxyl group.

9. The support of claim 1, wherein the tie layer is derived from a straight or branched-chain aminosilane, aminoalkoxysilane, aminoalkylsilane, aminoarylsilane, aminoaryloxysilane, or a derivative or salt thereof.

10. The support of claim 1, wherein the tie layer is derived from N-(beta-aminoethyl)-3-aminopropyl trimethoxysilane, N-(beta-aminoethyl)-3-aminopropyl triethoxysilane, N′-(beta-aminoethyl)-3-aminopropyl methoxysilane, or aminopropylsilsesquixoane.

11. The support of claim 1, wherein the tie layer is derived from 3-aminopropyl trimethoxysilane.

12. The support of claim 1, wherein the tie layer is not derived from a triamine compound.

13. The support of claim 1, wherein the epoxide layer is derived from a bis-epoxide compound.

14. The support of claim 13, wherein the bis-epoxide compound has the formula II 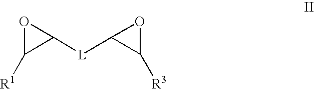
wherein L is a residue of a linker; and
R¹ and R³ are, independently hydrogen, an alkyl group, a polyether group, a polyamino group, or a polythioether group.

15. The support of claim 14, wherein the linker L comprises a residue of an ether group, a polyalkylene group, a polyether group, a polyamino group, group, or a polythioether group.

16. The support of claim 14, wherein the linker L has the formula CH₂Y(CH₂)ₙZCH₂, wherein Y and Z are, independently, S, O, or NR⁴, wherein R⁴ is hydrogen or an alkyl group, and n is an integer from 1 to 10,000.

17. The support of claim 14, wherein the linker L has the formula CH₂Y(CH₂)ₙZCH₂, wherein Y and Z are, independently, S, O, or NR⁴, wherein R⁴ is hydrogen or an alkyl group, and n is an integer from 1 to 10.

18. The support of claim 14, wherein the linker L has the formula CH₂O(CH₂)ₙOCH₂, wherein n is 2, 3, 4 or 5.

19. The support of claim 18, wherein n is 2.

20. The support of claim 18, wherein n is 4.

21. The support of claim 18, wherein R¹ and R³ are hydrogen.

22. The support of claim 18, wherein the epoxide layer is derived from 1,4-butanediol diglycidyl ether; 1,2-ethylenediol diglycidyl ether; or ethylene glycol diglycidyl ether.

23. The support of claim 1, wherein the tie layer and epoxide layer comprises the residue of formula I 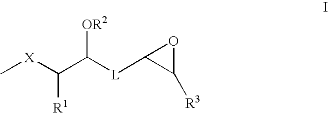
wherein X is a residue of the tie layer;
L is a residue of a linker; and
R¹, R², and R³ are, independently, hydrogen, an alkyl group, a polyalkylene group, a polyether group, a polyamino group, group, or a polythioether group, wherein the residue having the formula I is covalently attached to outer surface of the substrate through X.

24. The support of claim 23, wherein the linker L comprises a residue of an ether group, a polyalkylene group, a polyether group, a polyamino group, group, or a polythioether group.

25. The support of claim 23, wherein the linker L has the formula CH₂Y(CH₂)ₙZCH₂, wherein Y and Z are, independently, S, O, or NR⁴, wherein R⁴ is hydrogen or an alkyl group, and n is an integer from 1 to 10.

26. The support of claim 23, wherein the linker L has the formula CH₂O(CH₂)ₙOCH₂, wherein n is 2, 3, 4 or 5.

27. The support of claim 26, wherein n is 2.

28. The support of claim 26, wherein n is 4.

29. The support of claim 26, wherein R¹, R², and R³ are hydrogen.

30. The support of claim 26, wherein R² is hydrogen and R¹ and R³ are an alkyl group.

31. The support of claim 1, wherein the substrate comprises a porous, inorganic layer, the tie layer is derived from 3-aminopropyl trimethoxysilane, and the epoxide layer is derived from 1,4-butanediol diglycidyl ether.

32. The support of claim 1, wherein the support further comprises a biomolecule, wherein the biomolecule is covalently attached and/or non-covalently attached the epoxide layer.

33. The support of claim 32, wherein the biomolecule comprises a ribonucleic acid, a deoxyribonucleic acid, a synthetic oligonucleotide, an antibody, a protein, a peptide, a lectin, a modified polysaccharide, a synthetic composite macromolecule, a functionalized nanostructure, a synthetic polymer, a modified/blocked nucleotides/nucleoside, a modified/blocked amino acid, a fluorophore, a chromophore, a ligand, a chelate, or a hapten.

34. The support of claim 32, wherein the biomolecule comprises deoxyribonucleic acid or an oligonucleotide.

35. The support of claim 1, wherein the support is a slide, a microplate, or an array.

36. A method for preparing a support comprising (1) attaching a tie layer compound to the outer surface of a substrate, wherein the tie layer compound has at least one functional group capable of reacting with an epoxide group, and (2) reacting the tie layer with an epoxide compound having at least two epoxide groups to produce an epoxide layer, wherein the epoxide layer has at least one epoxide group.

37. The method of claim 36, wherein the substrate comprises a plastic, a polymeric or co-polymeric substance, a ceramic, a glass, a metal, a crystalline material, a noble or semi-noble metal, a metallic or non-metallic oxide, a transition metal, or any combination thereof.

38. The method of claim 36, wherein the substrate comprises a porous, inorganic layer.

39. The method of claim 38, wherein the inorganic layer comprises a glass or metal oxide.

40. The method of claim 38, wherein the inorganic layer comprises a silicate, an aluminosilicate, a boroaluminosilicate, a borosilicate glass, or a combination thereof.

41. The method of claim 38, wherein the inorganic layer is TiO₂, SiO₂, Al₂O₃, Cr₂O₃, CuO, ZnO, Ta₂O₅, Nb₂O₅, or ZnO₂.

42. The method of claim 36, wherein the functional group of the tie layer compound comprises an amino group, a thiol group, or a hydroxyl group.

43. The method of claim 36, wherein the tie layer compound comprises a straight or branched-chain aminosilane, aminoalkoxysilane, aminoalkylsilane, aminoarylsilane, aminoaryloxysilane, or a derivative or salt thereof.

44. The method of claim 36, wherein the tie layer compound is N-(beta-aminoethyl)-3-aminopropyl trimethoxysilane, N-(beta-aminoethyl)-3-aminopropyl triethoxysilane, N′-(beta-aminoethyl)-3-aminopropyl methoxysilane, or aminopropylsilsesquixoane.

45. The method of claim 36, wherein the tie layer compound is 3-aminopropyl trimethoxysilane.

46. The method of claim 36, wherein the tie layer compound is not a triamine compound.

47. The method of claim 36, wherein the epoxide compound comprises a bis-epoxide compound.

48. The method of claim 36, wherein the epoxide compound has the formula II 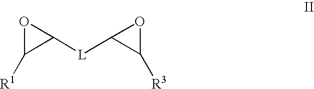
wherein L is a residue of a linker; and
R¹ and R³ are, independently, hydrogen, an alkyl group, a polyalkylene group, a polyether group, a polyamino group, group, or a polythioether group.

49. The method of claim 48, wherein the linker L comprises a residue of an ether group, a polyalkylene group, a polyether group, a polyamino group, group, or a polythioether group.

50. The method of claim 48, wherein the linker L has the formula CH₂Y(CH₂)ₙZCH₂, wherein Y and Z are, independently, S, O, or NR⁴, wherein R⁴ is hydrogen or an alkyl group, and n is an integer from 1 to 10,000.

51. The method of claim 48, wherein the linker L has the formula CH₂Y(CH₂)ₙZCH₂, wherein Y and Z are, independently, S, O, or NR⁴, wherein R⁴ is hydrogen or an alkyl group, and n is an integer from 1 to 10.

52. The method of claim 48, wherein the linker L has the formula CH₂O(CH₂)ₙOCH₂, wherein n is 2, 3, 4 or 5.

53. The method of claim 52, wherein n is 2.

54. The method of claim 52, wherein n is 4.

55. The method of claim 52, wherein R¹ and R³ are hydrogen.

56. The method of claim 36, wherein the epoxide compound is 1,4-butanediol diglycidyl ether; 1,2-ethylenediol diglycidyl ether; or ethylene glycol diglycidyl ether.

57. The method of claim 36, wherein the substrate comprises a porous, inorganic layer, the tie layer compound is 3-aminopropyl trimethoxysilane, and the epoxide compound is 1,4-butanediol diglycidyl ether.

58. The method of claim 36, wherein after step (2), attaching a biomolecule to the epoxide layer.

59. The method of claim 58, wherein the biomolecule is covalently attached to the epoxide layer.

60. The method of claim 58, wherein the biomolecule is non-covalently attached to epoxide layer.

61. The method of claim 58, wherein the biomolecule is covalently and non-covalently attached to the epoxide layer.

62. The method of claim 58, wherein the biomolecule comprises a ribonucleic acid, a deoxyribonucleic acid, a synthetic oligonucleotide, an antibody, a protein, a peptide, a lectin, a modified polysaccharide, a synthetic composite macromolecule, a functionalized nanostructure, a synthetic polymer, a modified/blocked nucleotides/nucleoside, a modified/blocked amino acid, a fluorophore, a chromophore, a ligand, a chelate, or a hapten.

63. The method of claim 58, wherein the biomolecule comprises a deoxyribonucleic acid or an oligonucleotide.

64. The method of claim 36, wherein the support is a slide, a microplate, or an array.

65. The method of claim 36, wherein the tie layer and the epoxide compound are reacted in the solution phase.

66. The method of claim 36, wherein in step (2), the epoxide compound is condensed on the tie layer, wherein the epoxide compound reacts with the tie layer.

67. The method of claim 66, wherein step (2) is performed by chemical vapor deposition.

68. A method for preparing a support comprising (1) attaching a tie layer compound to the outer surface of a substrate, wherein the tie layer compound has at least one functional group capable of reacting with an epoxide group, and (2) reacting the tie layer with an epoxide compound having at least two epoxide groups to produce an epoxide layer, wherein the epoxide layer has at least one epoxide group, wherein step (2) is performed by chemical vapor deposition.

69. A support made by the method of claim 36.

70. A support made by the method of claim 58.

71. A method for performing an assay of a ligand, comprising (1) contacting the ligand with a support comprising a substrate having an outer surface, a tie layer, an epoxide layer, and a biomolecule, wherein the tie layer is attached to the outer surface of the substrate, the epoxide layer is attached to the tie layer, wherein the epoxide layer has at least one epoxide group, wherein the biomolecule is covalently attached and/or non-covalently attached the epoxide layer, and (2) detecting the immobilized ligand.

72. The method of claim 71, wherein the ligand comprises a drug, an oligonucleotide, a nucleic acid, a protein, a peptide, an antibody, an antigen, a hapten, or a small molecule.

73. The method of claim 71, wherein the substrate comprises a plastic, a polymeric or co-polymeric substance, a ceramic, a glass, a metal, a crystalline material, a noble or semi-noble metal, a metallic or non-metallic oxide, a transition metal, or any combination thereof.

74. The method of claim 71, wherein the substrate comprises a porous, inorganic layer.

75. The method of claim 74, wherein the inorganic layer comprises a glass or metal oxide.

76. The method of claim 74, wherein the inorganic layer comprises a silicate, an aluminosilicate, a boroaluminosilicate, a borosilicate glass, or a combination thereof.

77. The method of claim 74, wherein the inorganic layer is TiO₂, SiO₂, Al₂O₃, Cr₂O₃, CuO, ZnO, Ta₂O₅, Nb₂O₅, or ZnO₂.

78. The method of claim 71, wherein the functional group of the tie layer compound comprises an amino group, a thiol group, or a hydroxyl group.

79. The method of claim 71, wherein the tie layer compound comprises a straight or branched-chain aminosilane, aminoalkoxysilane, aminoalkylsilane, aminoarylsilane, aminoaryloxysilane, or a derivative or salt thereof.

80. The method of claim 71, wherein the tie layer compound is N-(beta-aminoethyl)-3-aminopropyl trimethoxysilane, N-(beta-aminoethyl)-3-aminopropyl triethoxysilane, N′-(beta-aminoethyl)-3-aminopropyl methoxysilane, or aminopropylsilsesquixoane.

81. The method of claim 71, wherein the tie layer compound is 3-aminopropyl trimethoxysilane.

82. The method of claim 71, wherein the tie layer compound is not a triamine compound.

83. The method of claim 71, wherein the epoxide compound comprises a bis-epoxide compound.

84. The method of claim 71, wherein the epoxide compound has the formula II 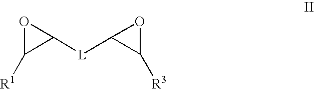
wherein L is a residue of a linker; and
R¹ and R³ are, independently, hydrogen, an alkyl group, a polyalkylene group, a polyether group, a polyamino group, group, or a polythioether group.

85. The method of claim 84, wherein the linker L comprises a residue of an ether group, a polyalkylene group, a polyether group, a polyamino group, group, or a polythioether group.

86. The method of claim 84, wherein the linker L has the formula CH₂Y(CH₂)ₙZCH₂, wherein Y and Z are, independently, S, O, or NR⁴, wherein R⁴ is hydrogen or an alkyl group, and n is an integer from 1 to 10,000.

87. The method of claim 84, wherein the linker L has the formula CH₂Y(CH₂)ₙZCH₂, wherein Y and Z are, independently, S, O, or NR⁴, wherein R⁴ is hydrogen or an alkyl group, and n is an integer from 1 to 10.

88. The method of claim 84, wherein the linker L has the formula CH₂O(CH₂)ₙOCH₂, wherein n is 2, 3, 4 or 5.

89. The method of claim 88, wherein n is 2.

90. The method of claim 88, wherein n is 4.

91. The method of claim 88, wherein R¹ and R³ are hydrogen.

92. The method of claim 71, wherein the epoxide compound is 1,4-butanediol diglycidyl ether; 1,2-ethylenediol diglycidyl ether; or ethylene glycol diglycidyl ether.

93. The method of claim 71, wherein the substrate comprises a porous, inorganic layer, the tie layer compound is 3-aminopropyl trimethoxysilane, and the epoxide compound is 1,4-butanediol diglycidyl ether.

94. The method of claim 71, wherein the biomolecule is covalently attached to the epoxide layer.

95. The method of claim 71, wherein the biomolecule is non-covalently attached to epoxide layer.

96. The method of claim 71, wherein the biomolecule is covalently and non-covalently attached to the epoxide layer.

97. The method of claim 71, wherein the biomolecule comprises a ribonucleic acid, a deoxyribonucleic acid, a synthetic oligonucleotide, an antibody, a protein, a peptide, a lectin, a modified polysaccharide, a synthetic composite macromolecule, a functionalized nanostructure, a synthetic polymer, a modified/blocked nucleotides/nucleoside, a modified/blocked amino acid, a fluorophore, a chromophore, a ligand, a chelate, or a hapten.

98. The method of claim 71, wherein the biomolecule comprises a deoxyribonucleic acid or an oligonucleotide.

99. The method of claim 71, wherein the support is a slide, a microplate, or an array.

100. The method of claim 71, wherein the immobilized ligand is detected by fluorescence or label independent detection.

101. The method of claim 71, wherein the ligand comprises a drug, an oligonucleotide, a nucleic acid, a protein, a peptide, an antibody, an antigen, a hapten, or a small molecule.

102. The method of claim 71, wherein the immobilized ligand is detected by fluorescence or label-independent detection.

103. A kit for immobilizing a biomolecule, comprising (1) a support comprising a substrate having an outer surface, wherein a tie layer is attached to the outer surface of the substrate, wherein the tie layer comprises at least one functional group capable of reacting with an epoxide group, and (2) an epoxide compound having at least two epoxide groups.
